(19) United States
(12) Patent Application Publication
(10) Pub. No.: US 2019/0141910 A1
(43) Pub. Date: May 16, 2019

(54) ARCHITECTURE FOR VERTICAL FARMING

(71) Applicant: Skyscraper Farm LLC, Alexandria, VA (US)

(72) Inventor: Lawrence Marek, New York, NY (US)

(21) Appl. No.: 15/893,241

(22) Filed: Feb. 9, 2018

Related U.S. Application Data
(63) Continuation-in-part of application No. 15/378,927, filed on Dec. 14, 2016.
(60) Provisional application No. 62/267,192, filed on Dec. 14, 2015.

(51) Int. Cl. A01G 9/14; E04H 5/08; G02B 5/26

(52) U.S. Cl. CPC A01G 9/14; G02B 5/26; E04H 5/08

(57) ABSTRACT

The present invention provides an architecture for performing vertical farming. The embodiments of the present invention disclose an arrangement of a plurality of reflective surfaces to maximize the amount of most beneficial natural light that can be gathered. The pluralities of reflective surfaces are arranged strategically in the polygonal architecture to direct the available natural light to the furthest reach of the growing area. Additionally, the architecture provides spiral arrangement of one or more growing panels where each growing panel is at predetermined height from the preceding growing panel.

### CROSS-REFERENCE TO RELATED APPLICATIONS

This application is a continuation-in-part of U.S. patent application Ser. No. 15/378,927 filed Dec. 14, 2016, now pending, which claims the benefit of U.S. provisional Patent Application Ser. No. 62/267,192 filed Dec. 14, 2015; the disclosures of each of which are hereby incorporated by reference in their entirety.

### FIELD OF THE INVENTION

The present invention relates to an architecture for vertical farming, and more particularly, to a structure for capturing the maximum amount of natural light in the vertical farm growing areas.

### BACKGROUND

Vertical farming is the process of growing crops in a vertically stacked manner integrated into other structures such as in buildings, warehouses and the like. The conventional methods of performing vertical farming uses indoor farming techniques and other agricultural technologies that help in controlling all the environmental factors such as light, temperature, fertilizers, gases, soil amendments, water solubility, pesticides, fungicides, herbicides, etc.

One of the important factors toward growth of plants is photosynthesis process. The conventional way of vertical farming utilizes light emitting diodes and other power sources for generating light for the photosynthesis process. For instance, in some arrangement, various columns of LED lights are provided above each layer of the crop, so that they can convert light of certain wavelengths or light energy from the LED lights into chemical energy, and store it for future use.

Often, the conventional vertical farming also utilizes natural lights for growing the crops. However, in some areas, the sunlight does not penetrate very far into interiors of the growing crops because of its climate. In the end, this approach also requires the addition of artificially powered light sources driven by any external power source to grow the crops. Because of the less penetration of natural light to the furthest corners of the growing area, the amount of electrical energy required to power the LED lights to grow the crops is increased. This results in increasing the cost of operation as well as the amount of greenhouse gases released into the atmosphere from the electricity generating plants that supply the power.

Therefore, there is a need for an inventive approach that can overcome the limitations associated with conventional vertical farming. In order to solve the aforementioned problems, the present invention provides an architecture where various reflective surfaces are placed to capture the maximum amount of natural light at the growing areas.

### SUMMARY

The present invention provides an architecture that addresses the deficiencies of the conventional solutions. The present invention presents an architectural structure for housing the vertical farming growing equipment to capture the maximum amount of natural light at the growing areas. This invention also presents a novel approach for the placement of the reflective surfaces to direct the available natural light to the furthest reach of the growing area.

The present invention also discloses a spiral arrangement of growing panels that maximizes gathering of the most beneficial natural light.

In an aspect of the present invention, an architecture for vertical farming system is provided. The architecture for vertical farming system comprises: a polygonal central core structure; a polygonal exterior structure surrounding the polygonal central core structure to create a plurality of segments around central core structure; one or more horizontal surfaces positioned at each segment, such that said one or more horizontal surface at each segment is higher than the horizontal surface at preceding segment by a predefined height; and a plurality of reflective surfaces positioned between the central core structure and the polygonal exterior structure for reflecting the light internally in the architecture. The polygonal central core structure is clad with reflective material at places to reflect the light. The plurality of reflective surfaces are made of metal or plastic or glass or the like and have a silver or matte black coating at the exterior side of the layer.

The polygonal exterior structure is made of a plurality of glass panes which consist of: a first layer which is outside the pane to the exterior, a second layer which is inside to the pane to the exterior, a third layer which is outside to the pane closest to the interior and the fourth layer which is inside of the pane closest to the interior of the architecture. The second layer is coated with a film to pass beneficial part of spectrum of the sunlight to one or more growing areas and to block an undesirable spectrum of the sunlight. The third layer is coated with a coating to allow desirable sunlight to pass through from the exterior and to reflect light received from the second layer back into the interior of the architecture. The plurality of reflective surfaces are positioned to trap and direct the maximum of the sunlight to one or more growing areas of the architecture. The plurality of horizontal surfaces are used for placing a plurality of growing panels. The plurality of growing panels create a spiral structure to maximize the accumulation of the sunlight to grow crops in the vertical farming. The polygonal structure is an octagonal structure. The lowest horizontal surface of the plurality of horizontal surfaces faces the east direction. A screen is provided at the west side of the architecture to block harmful sun rays. The polygonal central core structure comprises one or more access means to the system.

### BRIEF DESCRIPTION OF DRAWINGS

The preferred embodiment of the invention will hereinafter be described in conjunction with the appended drawings provided to illustrate and not to limit the scope of the invention, wherein like designation denotes like element and in which:

FIG. 1 illustrates a top perspective view of an architecture of a vertical farming system, in accordance with an embodiment of the present invention.

FIG. 2 illustrates the surface of specially designed glass used in exterior structure of the vertical farming architecture, in accordance with an embodiment of the present invention.

FIG. 3 illustrates an arrangement of the horizontal surfaces in the vertical farming system, in accordance with an embodiment of the present invention.

FIG. 4 illustrates representation of the vertical farming system with sun elevation at east and west, in accordance with an embodiment of the present invention.

FIG. 5 illustrates distribution of light in a vertical plane, in accordance with an embodiment of the present invention.

FIG. 6 illustrates a specially designed reflective surface clad on the polygonal central core structure used for east and west elevation of sun, in accordance with an embodiment of the present invention.

FIG. 7 illustrates a specially designed reflective surface clad on the polygonal central core structure used for south-east and south-west elevation of sun, in accordance with an embodiment of the present invention.

FIG. 8 illustrates a specially designed reflective surface clad on the polygonal central core structure used for south elevation of sun, in accordance with an embodiment of the present invention.

FIG. 9 illustrates a plan of dispersion pattern from east and west direction of sun, in accordance with an embodiment of the present invention.

FIG. 10 illustrates a plan of dispersion pattern from south-east and south-west direction of sun, in accordance with an embodiment of the present invention.

FIG. 11 illustrates a plan of dispersion pattern from south direction of sun, in accordance with an embodiment of the present invention.

FIG. 12 is a close up depiction of a skyscraper embodiment of the present invention.

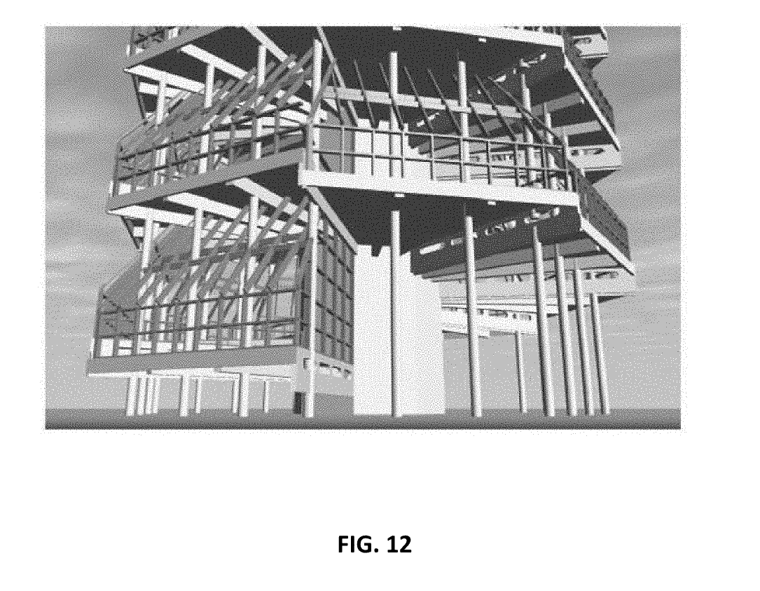

FIG. 13 is a depiction of a skyscraper embodiment of the present invention.

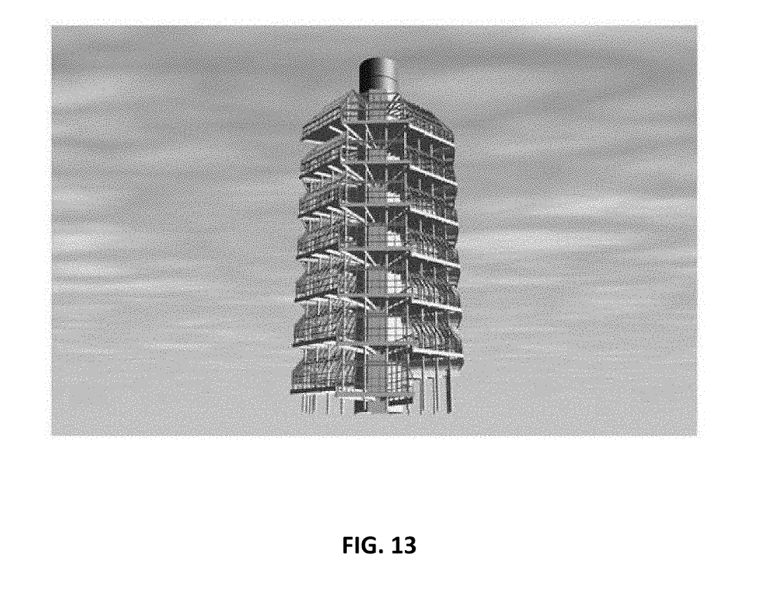

FIG. 14 is a close up depiction of a skyscraper embodiment of the present invention.

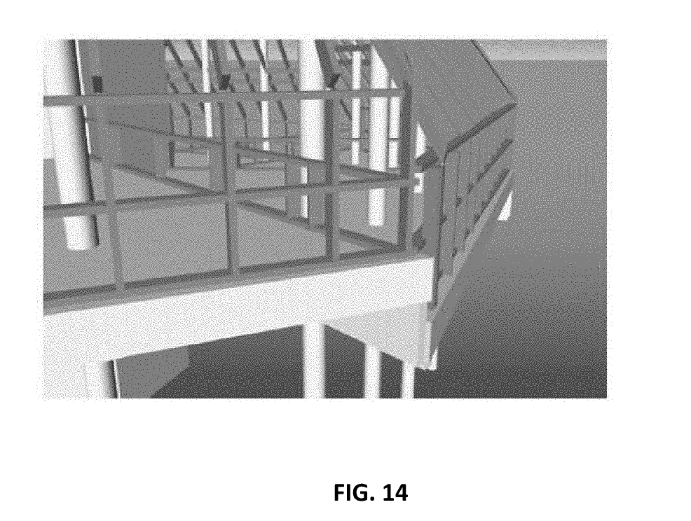

FIG. 15 is a close up depiction of the bottom of a skyscraper embodiment of the present invention.

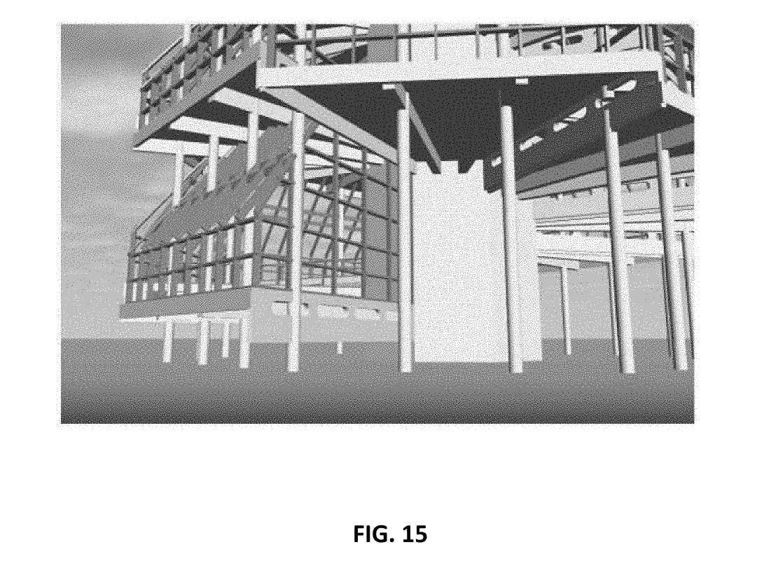

FIG. 16 is a close up depiction of the side of a skyscraper embodiment of the present invention.

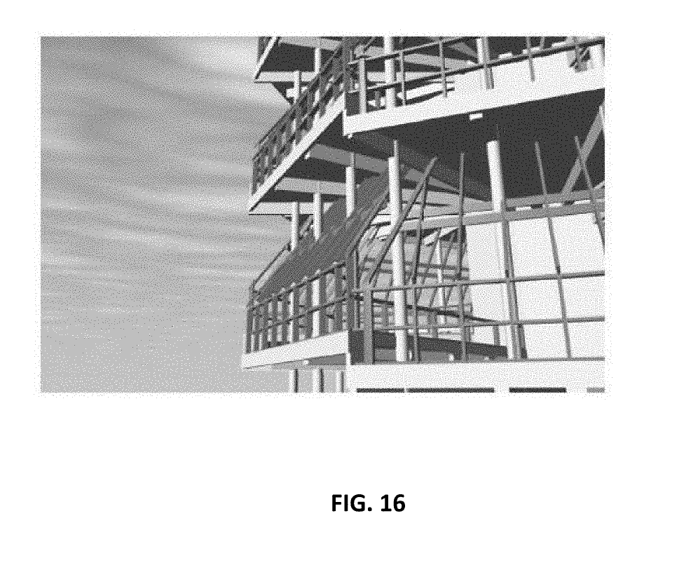

FIG. 17 is a close up depiction of an interior floor of a skyscraper embodiment of the present invention.

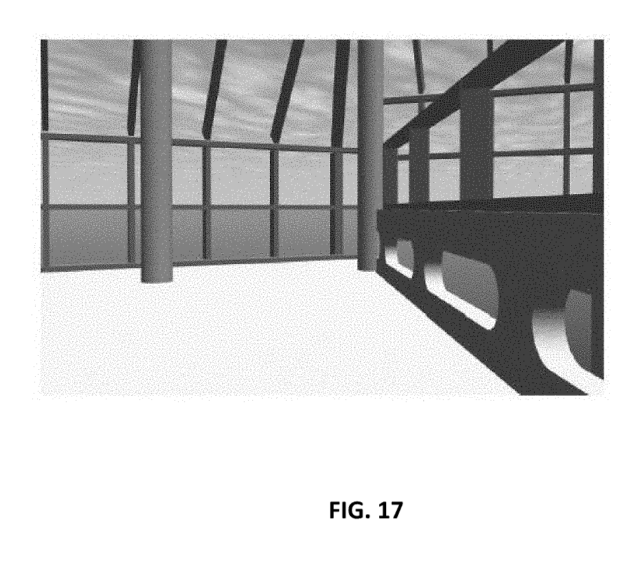

FIG. 18 is a close up depiction of interior windows of a skyscraper embodiment of the present invention.

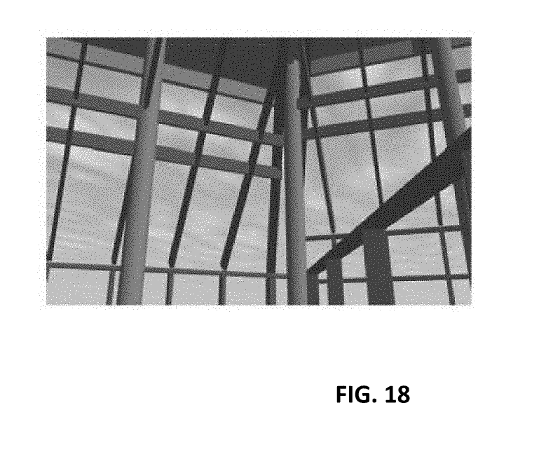

FIG. 19 is a cross section of a skyscraper embodiment of the present invention.

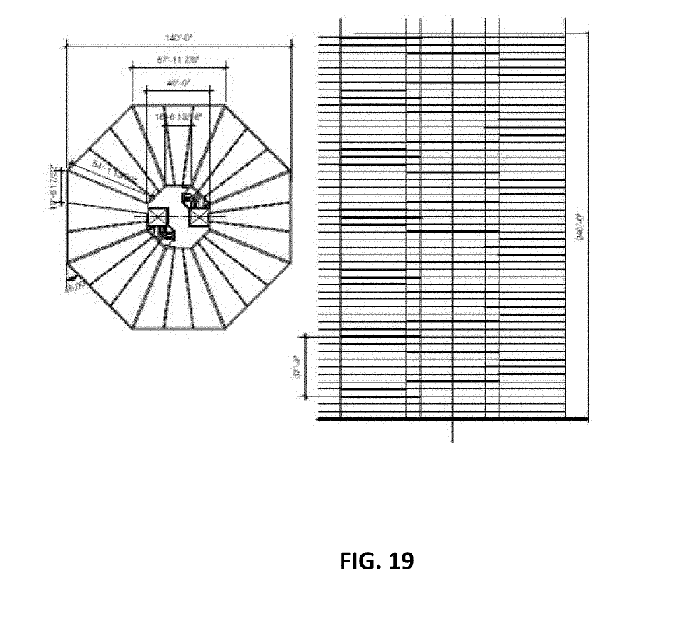

FIG. 20 is blown out view of basic components and a basic module of a skyscraper embodiment of the present invention.

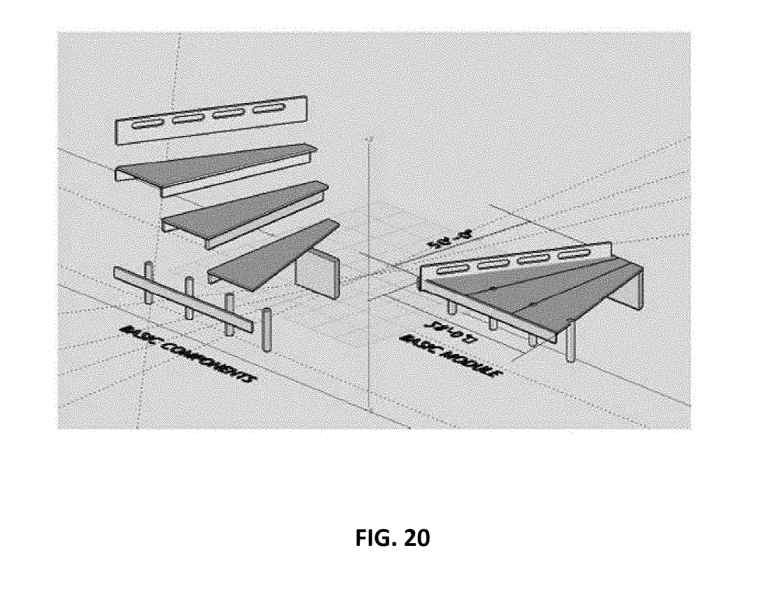

FIG. 21 is a depiction of a piece of a skyscraper embodiment of the present invention.

FIG. 22 is a depiction of another piece of a skyscraper embodiment of the present invention.

FIG. 23 is a depiction of yet another piece of a skyscraper embodiment of the present invention.

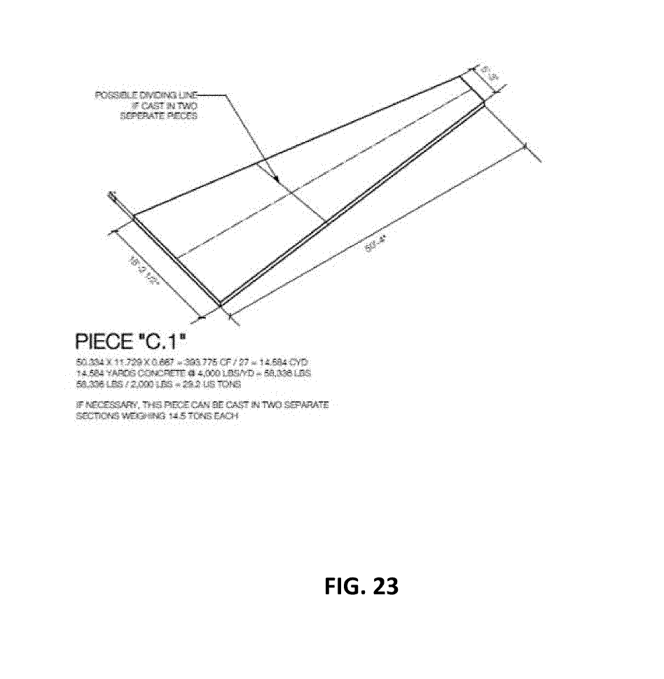

FIG. 24 is a depiction of yet another piece of a skyscraper embodiment of the present invention.

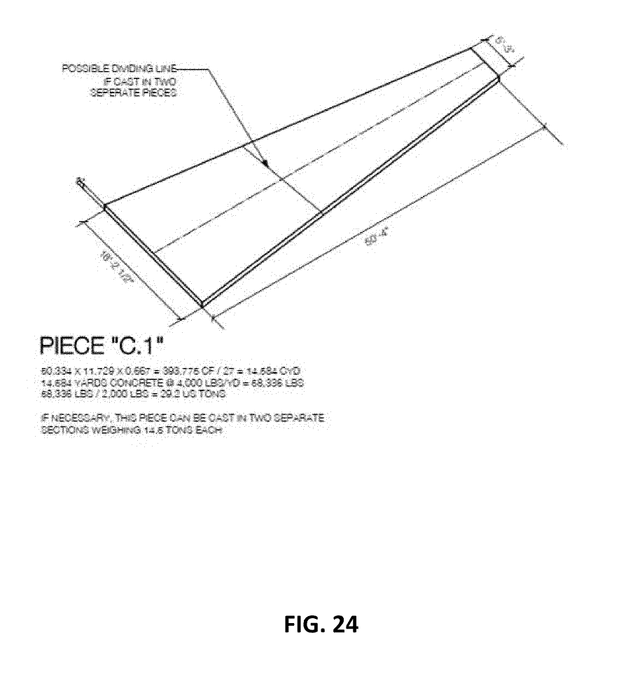

FIG. 25 is a depiction of yet another piece of a skyscraper embodiment of the present invention.

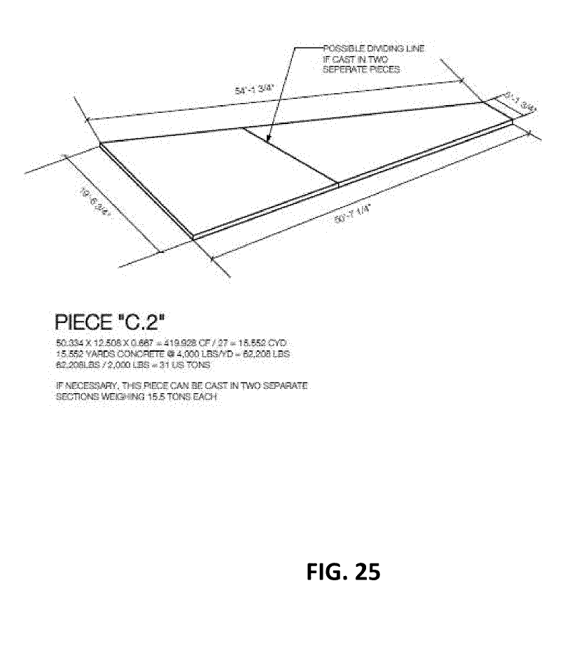

FIG. 26 is a depiction of a further piece of a skyscraper embodiment of the present invention.

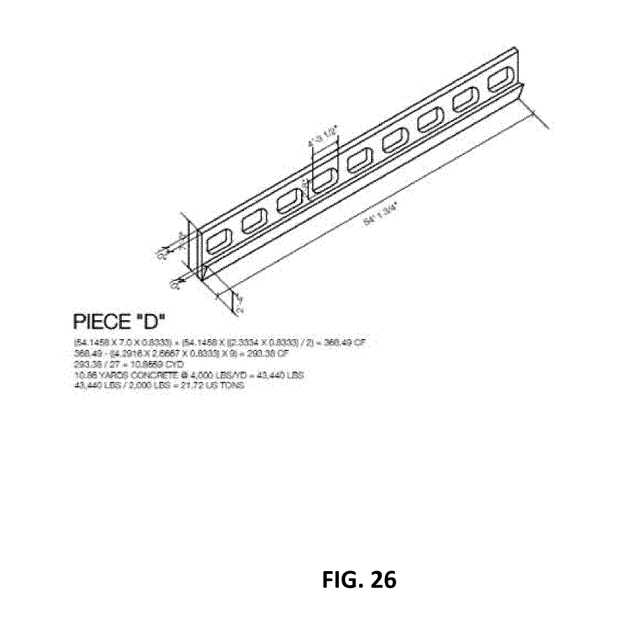

FIG. 27 is a depiction of yet another piece of a skyscraper embodiment of the present invention.

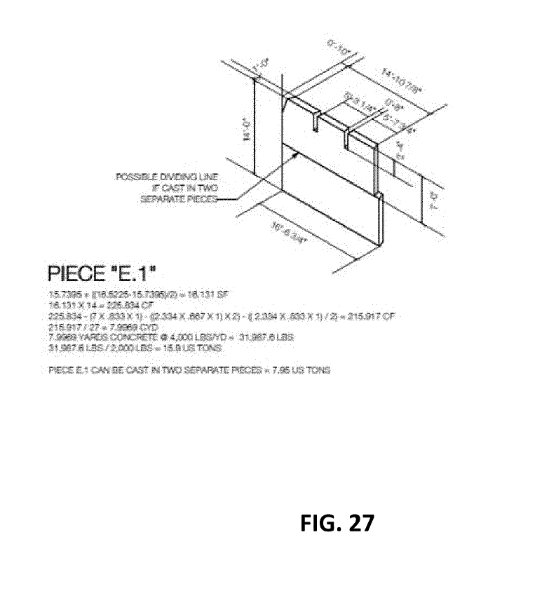

FIG. 28 is a depiction of yet another piece of a skyscraper embodiment of the present invention.

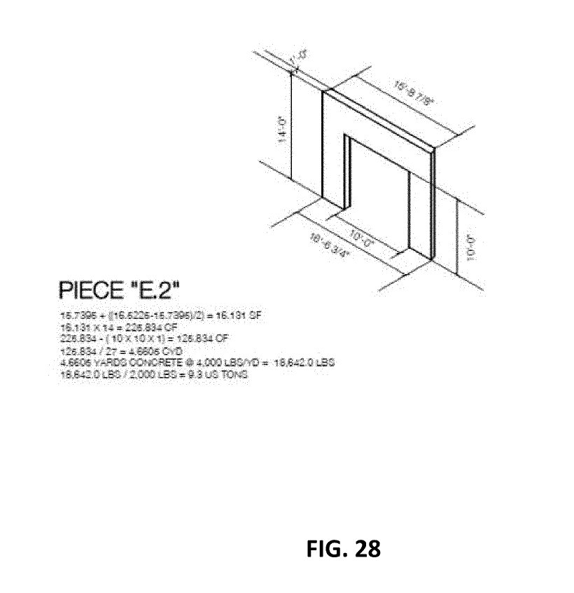

FIG. 29 is a depiction of yet another piece of a skyscraper embodiment of the present invention.

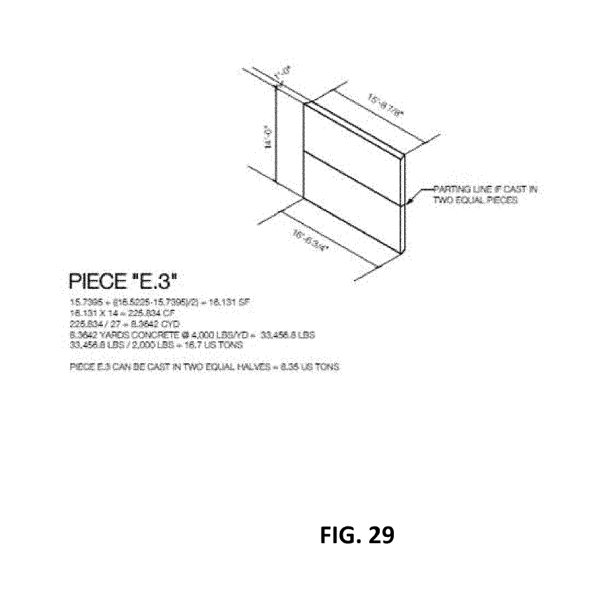

FIG. 30 is a depiction of yet another piece of a skyscraper embodiment of the present invention.

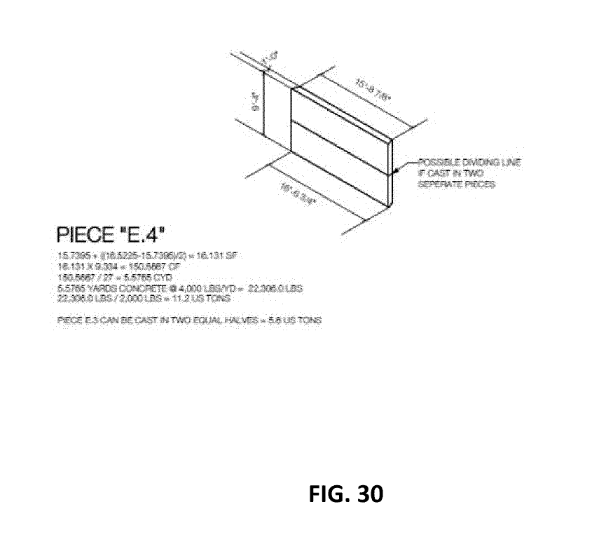

FIG. 31 is a depiction of component pieces of a skyscraper embodiment of the present invention.

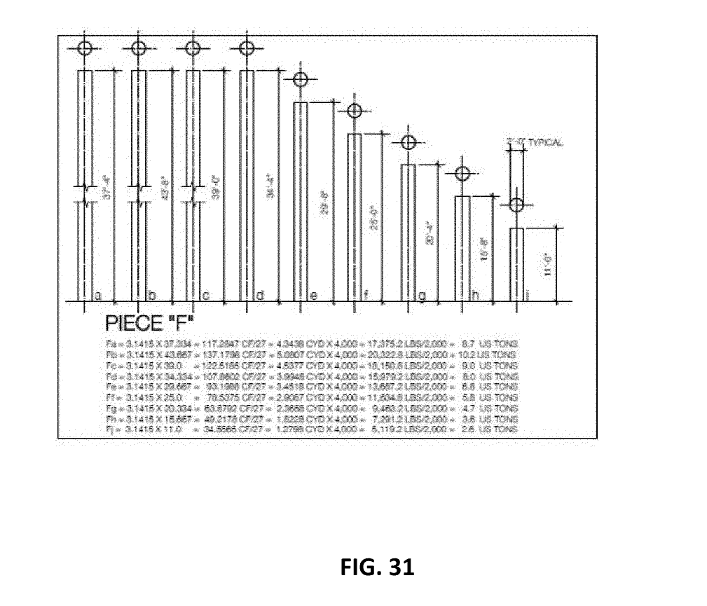

FIG. 32 is a depiction of a pie shaped glass enclosure in an embodiment of the present invention.

FIG. 33 is a depiction of another pie shaped glass enclosure in an embodiment of the present invention.

FIG. 34 is a depiction of another pie shaped glass enclosure in an embodiment of the present invention.

FIG. 35 is a depiction of another pie shaped glass enclosure in an embodiment of the present invention.

### DETAILED DESCRIPTION

In the following detailed description of embodiments of the invention, numerous specific details are set forth in order to provide a thorough understanding of the embodiments of the invention. However, it will be obvious to a person skilled in art that the embodiments of the invention may be practiced with or without these specific details. In other instances, well known methods, procedures and components have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

In an embodiment of the present invention, an architectural structure for housing a vertical farming growing equipment is provided to capture the maximum amount of natural light at growing panels or areas. By capturing the maximum amount of natural light, the amount of electrical energy required to power LED lights to grow the crops in the conventional vertical farming method is reduced, which results in savings in cost of operation. Additionally, the amount of greenhouse gases released into the atmosphere from the electricity generating plants that supply the power is also reduced.

The architectural structure comprises a polygonal central core structure; a polygonal exterior structure surrounding the core structure; a plurality of horizontal surfaces for mounting one or more growing panels arranged in equal segments around the central core structure. Each horizontal surface in a segment is at a predefined height than the preceding segment, going in a clockwise direction when viewed from above. The arrangement creates a spiral arrangement of the growing panels where the vertical separation between growing panels in the same vertical line is at a predetermined distance. The spiral arrangement of the growing panels maximizes the accumulation of the most beneficial natural light to grow crops in the vertical farming. In a preferred embodiment, the central core and exterior structure are preferably in octagonal configuration.

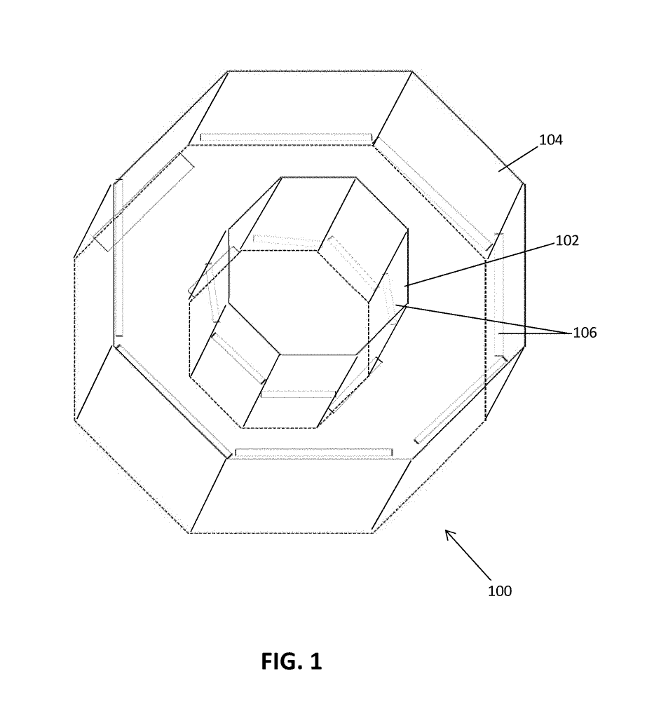

FIG. 1 illustrates a top perspective view of an architecture of a vertical farming system, in accordance with an embodiment of the present invention. The architectural structure 100 comprises a polygonal central core structure 102; a polygonal exterior structure surrounding the core structure 104; a plurality of horizontal surfaces 106 for mounting a plurality of growing panels arranged in equal segments between the polygonal central core structure 102 and the polygonal exterior structure 104. The polygonal central core structure 102 and the polygonal exterior structure 104 are preferably in octagonal configuration, and are designed in a manner that each segment of the architecture faces one of the eight directions. The plurality of horizontal surfaces 106 upon which the growing panels are mounted are arranged in eight equal segments around the central core in the plane configuration of a regular octagon. Each horizontal surface is at a predefined height than the preceding horizontal surface, going in a clockwise direction when viewed from above, thus creating a spiral arrangement of the plurality of growing panels.

The diameter of the polygonal exterior structure 104 and the polygonal central core structure 102 depends on the growing area required for the plantation. The architecture 100 is supported on a suitable foundation which can be made from number of materials such as stones, bricks, blocks, or treated wood by using reinforced concrete.

The polygonal exterior structure 104 is designed by placing a specially designed glass pane (not shown in FIG. 1) in a vertical manner. Spacers or mullions can be used in horizontal and vertical manner to build a framework with spaces in between for adjusting glasses. Alternatively the framework for the polygonal exterior structure 104 can be built using bricks and mortar. The polygonal exterior structure 104 can also be made with glass pane only without the need of any supportive hard framework. The glass panes allow the beneficial rays of sunlight to pass through into the interior of the vertical green house. The orientation of the glass on the exterior structure is vertical till a pre-determined height and above that pre-determined height it is at 90 degrees to the spring and fall equinae for the latitude of the tower. The glass section is designed to be same at each segment in order to keep the cost down. In a sophisticated version, the glass for each segment would slant at 90 degrees to the average surface normal for the sun at that direction.

The surface of the central core is a solid surface on which special reflective patterns can be clad for efficient internal reflection in such a manner that the farthest reach of the vertical house also gets the light from external source. The reflective surface at the core can be either metal or plastic with a reflective back surface. The space inside the core can be used for providing one or more access means such as elevators, fire stairs, vertical shafts for plumbing, electrical and climate control risers and work space to prepare produce for transport to the loading dock.

Inside the tower between the polygonal exterior structure 104 and the polygonal central core structure 102, a plurality of reflectors are placed to provide internal reflection so that the light reaches to the area where direct sunlight is not falling. The plurality of reflectors include a primary reflector and one or more secondary reflectors.

In order to correctly design the reflective surface at the central core surface and the plurality of reflectors, a ray trace light analysis is performed in a computer for models such as a building, a tower and the like, where the vertical farming is to be implemented. The ray trace analysis helps in adjusting the model for the optimal configuration at a particular latitude. Once the first case is optimized, then the same process is repeated for every three or four degrees of latitude from the equator to northern region such as Canada. Certainly, the configuration of the reflective surfaces will change from the equator to other region, such as Alberta. The accuracy is dependent on the accuracy of the computer aided design program that is used. There are light analyses programs that lighting designers use to determine the lumen intensity of light from all sources at a three dimensional grid of points throughout the space.

The optimized angles and dimensions for the corresponding model, as resulting from the ray trace analysis, are then used for placing the plurality of reflective surfaces to perform the vertical farming. The architecture shown in the present invention is designed to provide maximum sunlight to the crops.

Between the polygonal exterior structure 104 and the polygonal central core structure 102 the plurality of horizontal surfaces 106 are provided upon which the growing pane can be mounted. Starting from the east segment of the octagonal building, horizontal surfaces are provided at each segment such that each segment is higher than the preceding segment oriented in clockwise manner. The plurality of growing panels are mounted on the plurality of horizontal surfaces 106 which can be benches or any base that provide support to the plurality of growing panels. The size and configuration of the growing trays or panels that are used to grow the plants/crops vary depending on the system which is chosen to grow the crops. Alleyway is provided between the growing panels for movement of the user. The plurality of horizontal surfaces 106 are associated with one or more air handling unit that includes a fan, an air intake unit and an air outlet unit. The architecture provides the provision for distribution of water system in the growing panel.

The growing panels are also provided with lighting system for artificial lighting. The lighting fixtures include one or more reflectors and bulbs controlled by a ballast unit. One or more control units are provided to control the lighting system. The control unit, the electrical connections and the necessary control elements are provided in plurality of cabinets.

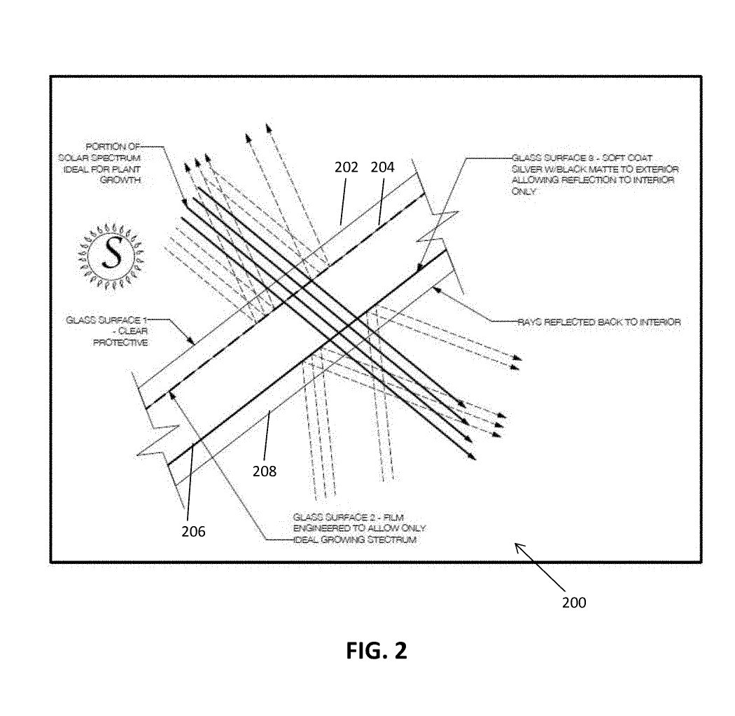

FIG. 2 illustrates the surface of specially designed glass used in exterior structure of the vertical farming architecture, in accordance with an embodiment of the present invention. In the specially designed glass 200 used in the polygonal exterior structure 104, the reflective surfaces are reversed. The specially designed glass 200 has four surfaces: the outside and inside of the pane to the exterior and the outside and the inside of the pane closest to the interior. The first surface 202 which is outside surface of the pane to the exterior is a clear surface that does not have any kind of coat or film. The second surface 204 which is inside surface of the pane to the exterior has a film that allows the most beneficial part of the spectrum of sunlight that contributes to plant growth, to pass through unimpeded, but blocks the rest of the spectrum. The third surface 206 which is outside of the pane closest to the interior has a soft coat, one way reflective film that allows the desirable sunlight to pass through from the exterior, but reflects the interior light rays back into the interior of the space. This soft coat is specifically developed for the vertical farm application and reflects light only to the interior side of the reflective panel. The fourth surface 208 which is inside of the pane closest to the interior is clear similar to the first surface. The film and coatings are placed only at the second surface 204 and the third surface 206 as these surfaces are the inner surfaces, thus remain protected from violent weather events on the exterior and from industrial operation on the interior as shown in FIG. 2.

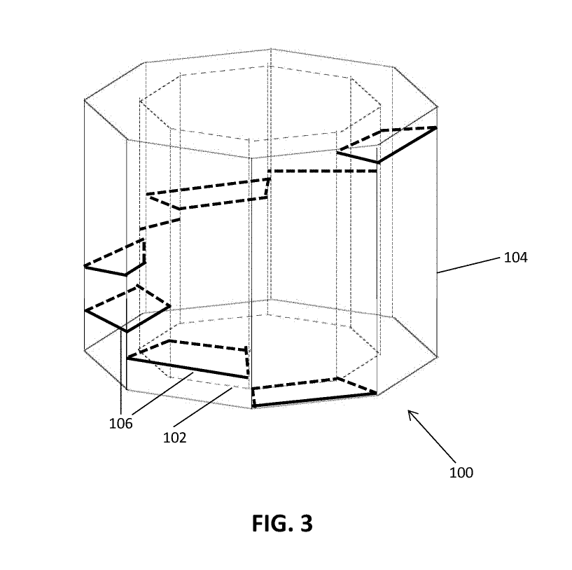

FIG. 3 illustrates an arrangement of the horizontal surfaces in the vertical farming system, in accordance with an embodiment of the present invention. The plurality of growing panels are mounted and arranged horizontally in equal segments around the polygonal central core structure 102, wherein the plurality of growing panels may vary in number and size depending on the structure which is chosen for vertical farming. The plurality of growing panels are sized to accommodate the variety of plants being grown in a plurality of growing cells and for ease in material handling.

In an aspect of the present invention, the architecture 100 is in octagonal shape, where the plurality of horizontal surfaces 106 are placed at each segment of the octagonal structure such that each horizontal surface is higher than the preceding horizontal surface, arranged in a clockwise direction. The difference between the heights of two adjacent horizontal surfaces is uniform throughout the architecture, which can be between 3 feet to 6 feet. In the preferable example, each segment in the octagonal structure is 4′-8″ higher than the preceding segment, going in a clockwise direction, as shown in FIG. 1 and FIG. 3. There are eight equal segments in the structure which create a vertical separation of 37′-4″ (4.6667×8=37.334) between two sequential horizontal surfaces 106 in the same vertical line. This results into the spiral arrangement of the horizontal surface and allows height for sun to penetrate into interior of the growing crops.

The number of horizontal surfaces used in the architecture depends upon the height of the architecture. The dimension of the plurality of growing panels depends on the diameter of the architecture 100. If the diameter of the architecture 100 is 200 feet where 80 feet is devoted to polygonal central core structure 102, then this leaves one half of the remaining 120 feet, or 60 feet from the polygonal central core structure 102 to the polygonal exterior structure 104 at the centerline. The width of the plurality of growing panels at the polygonal exterior structure 104 is pi*d divided by eight (3.14*200/8) or 78.5 feet. Similarly, the width of the plurality of growing panels at the polygonal central core structure 102 is pi*d divided by eight (3.14*80/8) or 31.41 feet.

The plurality of growing panels can be separated by horizontal strips. The plurality of growing panels are rectangular and span between the posts and are formed of a required height so that a specified number of the growing panels form a height of the wall up to the roof structure. The plurality of growing panels can be transparent to further allow passage of natural light into the growing area or greenhouse for providing energy to the plants/crops.

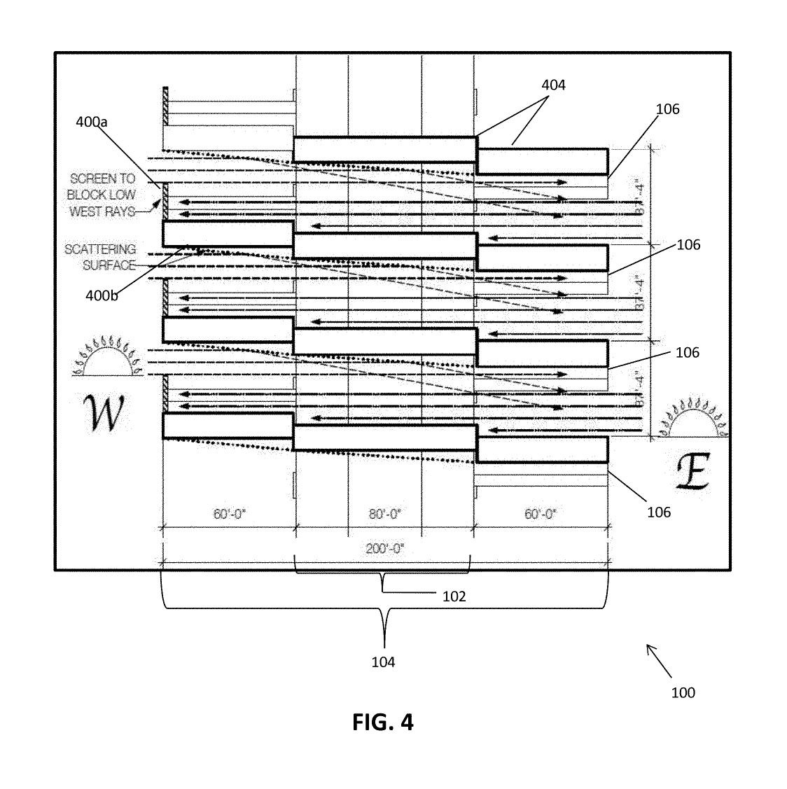

FIG. 4 illustrates representation of the vertical farming system with sun elevation at east and west, in accordance with an embodiment of the present invention. The vertical separation between the plurality of growing panels 404 placed at in the same vertical line is same throughout the architecture. The architecture is designed such that the horizontal surface facing east is at the ground level, whereas each preceding horizontal surface 106 is at a higher level. By always orienting the structure so that the lower part of the spiral is always pointing east, the beneficial morning sun is shone directly on the plants, while the less beneficial setting, western sun is directed to the underside of the growing panels.

In FIG. 4 when the sun elevation is at east, due to the presence of lower part at the east side, the distant part has unobstructed access to the sunlight. When the sun elevation is at west direction, the harmful sun radiation can cause harm to the growing plants. To overcome the effect of harmful radiation of the west side sun, a special screen 400a to block the west rays are provided on the exterior structure of the architecture. These special screen blocks the harmful west rays to reach to the growing panel. Due to spiral arrangement and octagonal structure, the horizontal surface facing the west sun is at high elevation, which makes the western sun directed to the underside of the growing panels. At the underside of the growing panels, a non-reflective surface 400b breaks up the harsh rays and scatters them over the growing area, mitigating their searing effect.

The present invention uses a plurality of reflective surfaces to distribute light in the interior of the architecture 100. The plurality of reflective surfaces are shown by using a solid-curved line. The plurality of reflective surfaces are placed strategically to reflect the sunlight to farthest reach. The scattered sunlight is shown by using a dashed-arrow line.

The plurality of reflective surfaces are slanted back at different angles for different seasons. For e.g. the angle can be of 90 degrees in case of spring and fall seasons for the latitude of the architecture 100. This helps in reducing the cost of the operation. In a sophisticated version, the plurality of reflective surfaces for each segment of the architecture 100 would slant at 90 degrees to the average surface normal for the sun at that compass direction. The segment at the mid-point always faces towards south.

The positioning of plurality of reflective surfaces can be arranged according to the climate. For instance, some of the reflective surfaces can be removed in winter setting or an additional reflective surface can be adjusted for summer settings.

The plurality of reflective surfaces can be arranged at various angles according to different weather events and sun's elevation. The octagonal shape of the polygonal central core structure 102 and the polygonal exterior structure 104 helps in directing the light to the corners of the growing areas that are hard to reach in normal configuration. By applying a reflective finish, specifically designed to reflect the light rays at controlled angles, in combination with the interior reflectors, incoming light can be scattered to all parts of the growing area.

In an embodiment, the architecture 100 may also include a lighting system for each growing panel, wherein the lighting system has a controlling unit and a plurality of electrical connection. Such lighting system can be used when the sunlight penetration is less in the growing areas.

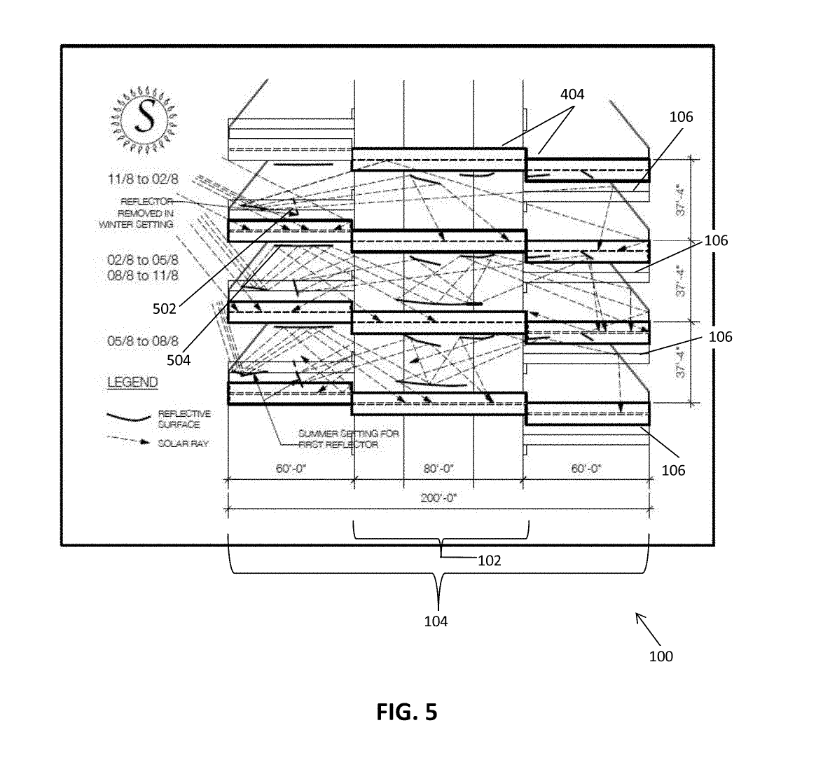

FIG. 5 illustrates distribution of light in a vertical plane, in accordance with an embodiment of the present invention. FIG. 5 shows distribution of solar rays in different seasons: winter season (November to February), spring and autumn season (February to May and August to November) and summer season (May to August). On the south orientation, the midday sun does not penetrate very far into the interior of the growing space. During winter (November to February), the sun is low in the northern hemisphere and therefore more light penetrates in the winter. A reflector 502 is removed in the winter setting and without the filter also, the solar rays reach the deep corner in the vertical greenhouse.

The position of sun in spring and autumn season is at mid-level, and therefore, the reflector 502 is positioned between the exterior structure and the central core. The reflector 502 helps in internal reflection of light such that the light can reach to growing areas.

In summer season, the sun is at the steepest angle; therefore, reflective surfaces are required to direct the sun's rays to the furthest corners of the growing area. The reflectors 502 and 504 are placed to enable the light to reach furthest area as shown in FIG. 5.

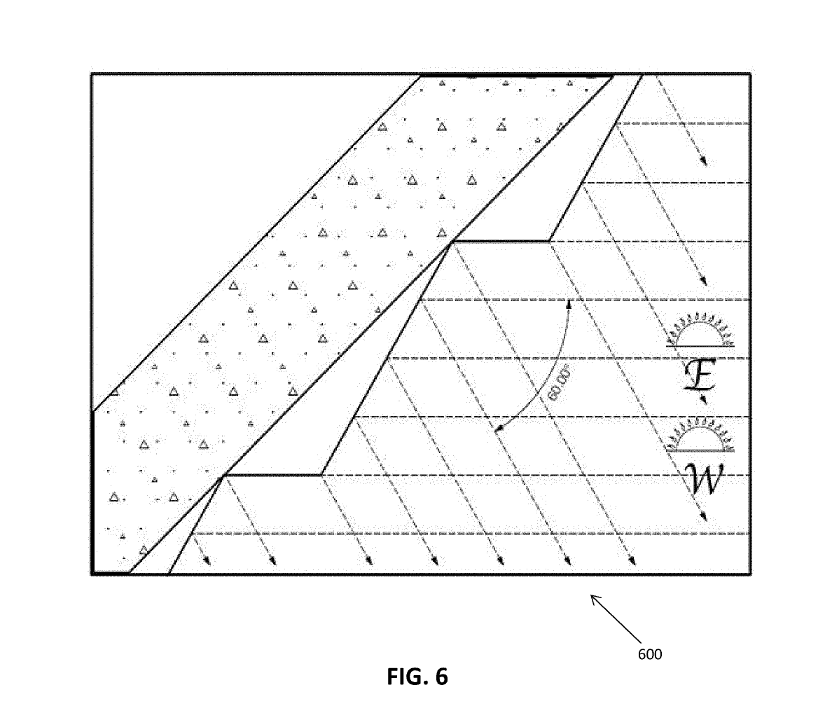

FIG. 6 illustrates a specially designed reflective surface clad on the polygonal central core structure used for east and west elevation of sun, in accordance with an embodiment of the present invention. The full range of daily sun activity is confined mainly to East/west, south-east/south-west and south direction. For the East and west direction sun, the reflective surface 600 clad on the polygonal central core structure is designed to reflect the light at 60 degrees.

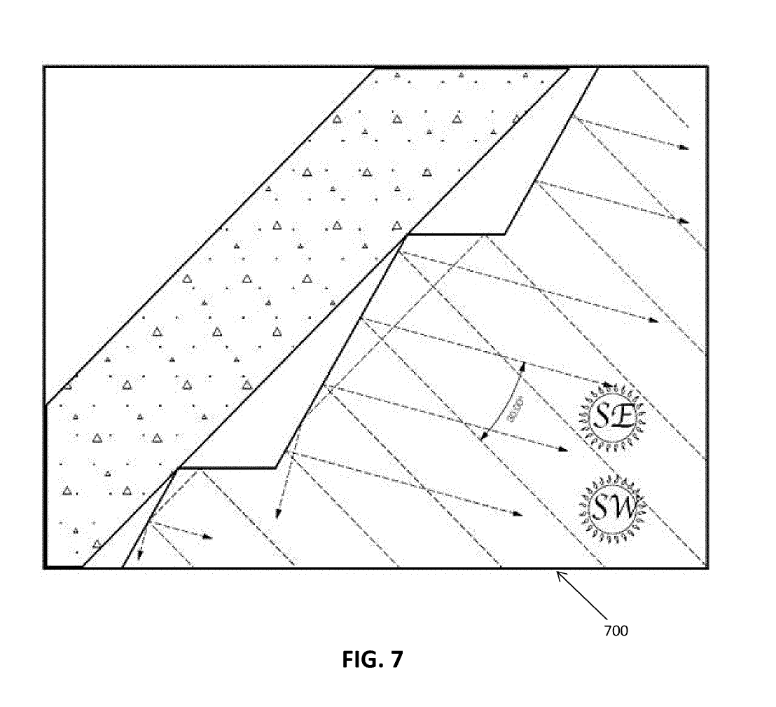

FIG. 7 illustrates a specially designed reflective surface clad on the polygonal central core structure used for south-east and south-west elevation of sun, in accordance with an embodiment of the present invention. When the sun is elevated in south-east and south-west position, the reflective surface 700 clad on the polygonal central core structure is arranged to reflect the sunlight that fall on the reflective surface 700 at an angle of 30 degrees between incident ray and reflected ray.

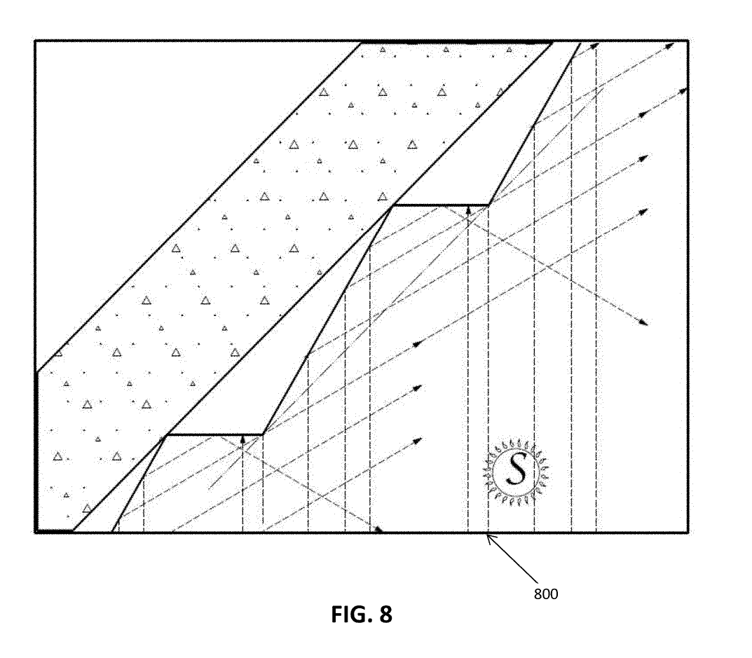

FIG. 8 illustrates a specially designed reflective surface clad on the polygonal central core structure used for south elevation of sun, in accordance with an embodiment of the present invention. The reflective surfaces 800 reflect the sunlight that fall on the reflective surfaces perpendicularly to angle of incidence.

Generally, light incident on the reflective surface is partially transmitted, partially reflected, and partially absorbed. As the sun goes higher in the sky, the fraction of light reflected from the reflective surface increases, leaving a reduced fraction of the light to be transmitted through the reflective surfaces. In this way, the specifically designed reflective surface can be used for various positions of sun to capture the full range of daily sun activity.

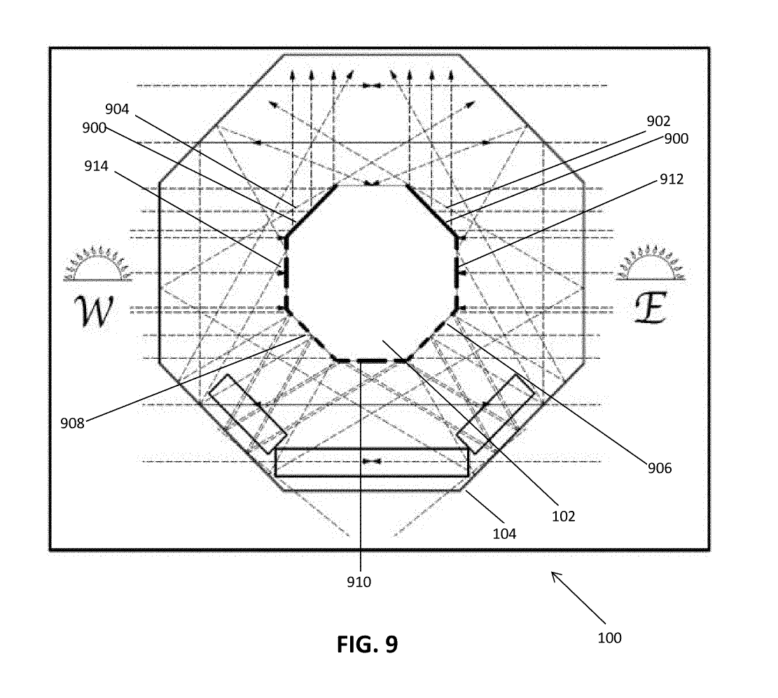

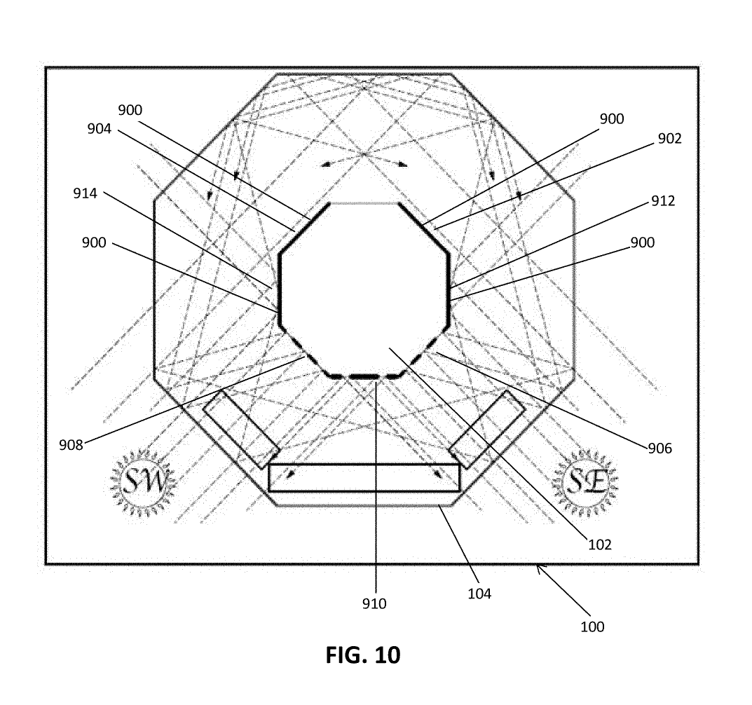

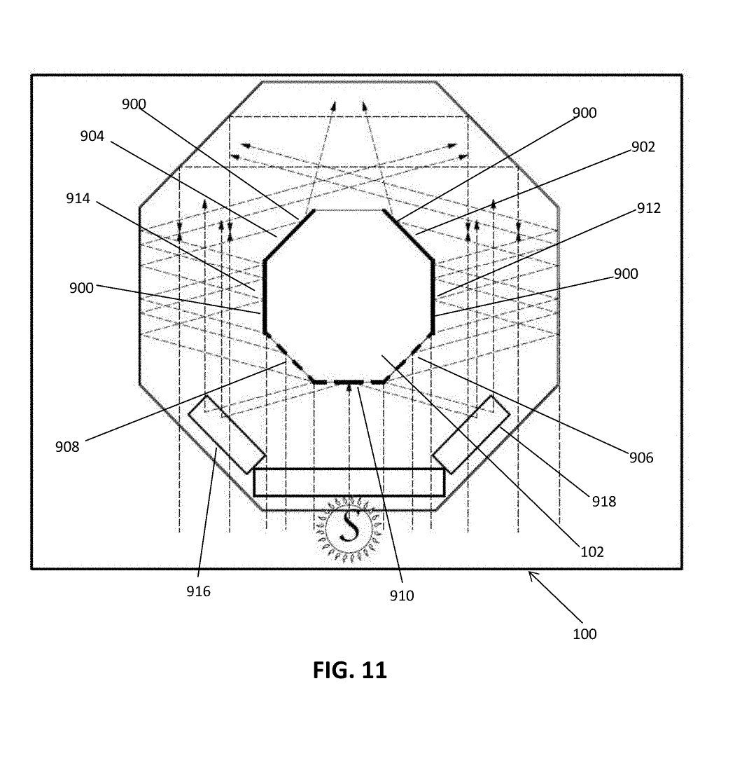

However, from the same sun orientations i.e. east/west, south-east/south-west and south, the north quadrant fails to receive the sunlight. To direct the sunlight to the north quadrant of the growing area, two sides of the polygonal central core structure 102, facing north-east 902 and north-west 904, clad in a straight reflective surface 900 that are not designed to reflect the sunlight at a specific angle are shown in FIG. 9, FIG. 10 and FIG. 11.

FIG. 9 illustrates a plan of dispersion pattern from east and west direction of sun, in accordance with an embodiment of the present invention. The north-east segment 902 and the north-west segment 904 of the polygonal central core structure 102 have a cladding of the straight reflective surface 900 that reflect the sunlight normally. The polygonal central core structure has intermittent coating of reflective surfaces at the east segment 912, the west segment 914, the south-east segment 906, the south-west segment 908 and the south segment 910. These directions are being clad in the reflective surface designed to direct the light at specific angle. The number of reflective surfaces can be increased or decreased according to the requirement. The reflective coating at the polygonal central core structure reflects the light coming from the directions between east and west directions. The reflected light from the reflective surface on the core are the reflected internally using the plurality of reflectors positioned in the architecture. Also, the glass pane used in the exterior structure has a specially designed layer which reflects the light rays internally into the architecture. The whole arrangement of the reflective surface at the central core structure and the plurality of reflectors placed in the architecture enables the light to reach the north quadrant of growing area.

FIG. 10 illustrates a plan of dispersion pattern from south-east and south-west direction of sun, in accordance with an embodiment of the present invention. When the sun is elevated in south-east and south-west direction, the east segment 912, the west segment 914, the north-east 902 and the north-west segment 904 of the polygonal central core structure 102 are clad in straight reflective material which are not designed to reflect the light at a specific angle. The surface at the south-east segment 906, the south-west segment 908 and the south segment 910 of the polygonal central core structure 102 are being clad in the reflective surface designed to direct the light at a specific angle. By cladding the polygonal core structure at specific position and using plurality of reflector, the light is transmitted to every corner of the growing area.

FIG. 11 illustrates a plan of dispersion pattern from south direction of sun, in accordance with an embodiment of the present invention. The polygonal central core structure is clad with straight reflective surface at east, west, north-east and north-west direction. The polygonal central core structure south-east, south and south-west direction is being clad with reflective surface designed to reflect the light at specific angle. When the Sun is in south direction, the specially designed reflective surface 910 on the south face of the polygonal central core structure is split at the midpoint to direct the light rays equally to the right and left direction. The splitted light then allows to fall on the reflective surface 916 placed in left side and the reflector 918 placed in the right side. The light after reflecting from reflector 916 and reflector 918 goes to the north quadrant of growing area.

Because of the shape of the earth, as one move away from the equator, the angle of incidence of sunlight gats more sharp during all hours of the day. Due to this reason, the calculation for the optimum angle and the placement of the reflective surface, the primary reflective surface and the non-reflective surface cannot be the same for different locations. The present invention hence provides an optimum configuration for the angle of the reflective surface by developing the plurality of reflective surfaces for every three degrees of latitude, starting at three degrees and going to seventy or eighty degrees of latitude. This gives a different configuration for approximately every two hundred miles of northern movement of the location of a vertical farm structure.

Thus, the present invention projects a light dispersion program that develops the optimum configuration for all of the components to maximize the harvesting of natural light for the efficient growing of crops. This will occur in a facility that will become more important as urbanization and land removed from agrarian uses, in conjunction with a burgeoning population, makes the production of food in a vertical structure necessary. The present invention provides an arrangement for growing the crops vertically in a continuous fashion throughout each year while implementing resource conservation as well as protecting the crops from weather-related problems.

TABLE 1
SCHEDULE OF PRECAST STRUCTURAL CONCRETE COMPONENTS
NEEDED TO CONSTRUCT A 240 FOOT HIGH VERTICAL FARM BUILDING

| PIECE | APPROXIMATE | WEIGHT PER | NUMBER | TOTAL |
|---|---|---|---|---|
| MARK | DIMENSIONS | PIECE | REQUIRED | WEIGHT |
| A | 58′ × 3′ × 0.667′ | 8.6 US Tons | 49 Pieces | 421.4 US Tons |
| B | 51′ × 2′ × 0.75′ | 6.5 US Tons | 98 Pieces | 637.0 US Tons |
| C1* | 51′ × 12′ × 0.667′ | 29.2 US Tons | 49 Pieces | 1,430.8 US Tons |
| C2* | 51′ × 12.667′ × 0.667′ | 31.0 US Tons | 98 Pieces | 3,038.0 US Tons |
| D | 54′ × 7′ × 0.833′ | 21.72 US Tons | 50 Pieces | 1,086.0 US Tons |
| E1* | 16′ × 14′ × 1′ | 15.9 US Tons | 49 Pieces | 779.1 US Tons |
| E2 | 16′ × 14′ × 1′ | 9.3 US Tons | 12 Pieces | 111.6 US Tons |
| E3* | 16′ × 14′ × 1′ | 16.7 US Tons | 37 Pieces | 617.9 US Tons |
| E4* | 16′ × 9.334′ × 1′ | 11.2 US Tons | 50 Pieces | 560 US Tons |
| Fa | 37.334′ × 2′ Diam. | 8.7 US Tons | 147 Pieces | 1,278.9 US Tons |
| Fb | 43.667′ × 2′ Diam. | 10.2 US Tons | 3 Pieces | 30.6 US Tons |
| Fc | 39.000′ × 2′ Diam. | 9.0 US Tons | 3 Pieces | 27.0 US Tons |
| Fd | 34.334′ × 2′ Diam. | 8.0 US Tons | 3 Pieces | 24.0 US Tons |
| Fe | 29.667′ × 2′ Diam. | 6.8 US Tons | 3 Pieces | 20.4 US Tons |
| Ff | 25.000′ × 2′ Diam. | 5.8 US Tons | 3 Pieces | 17.4 US Tons |
| Fg | 20.334′ × 2′ Diam. | 4.7 US Tons | 3 Pieces | 14.1 US Tons |
| Fh | 15.667′ × 2′ Diam. | 3.6 US Tons | 3 Pieces | 10.8 US Tons |
| Fi | 11.000′ × 2′ Diam. | 2.6 US Tons | 3 Pieces | 7.8 US Tons |

Pieces marked with an asterisk may be cast in two equal pieces doubling the number and halving the weight of each piece

See drawings for specific dimensions and weights of each piece and a diagram of the overall structure.

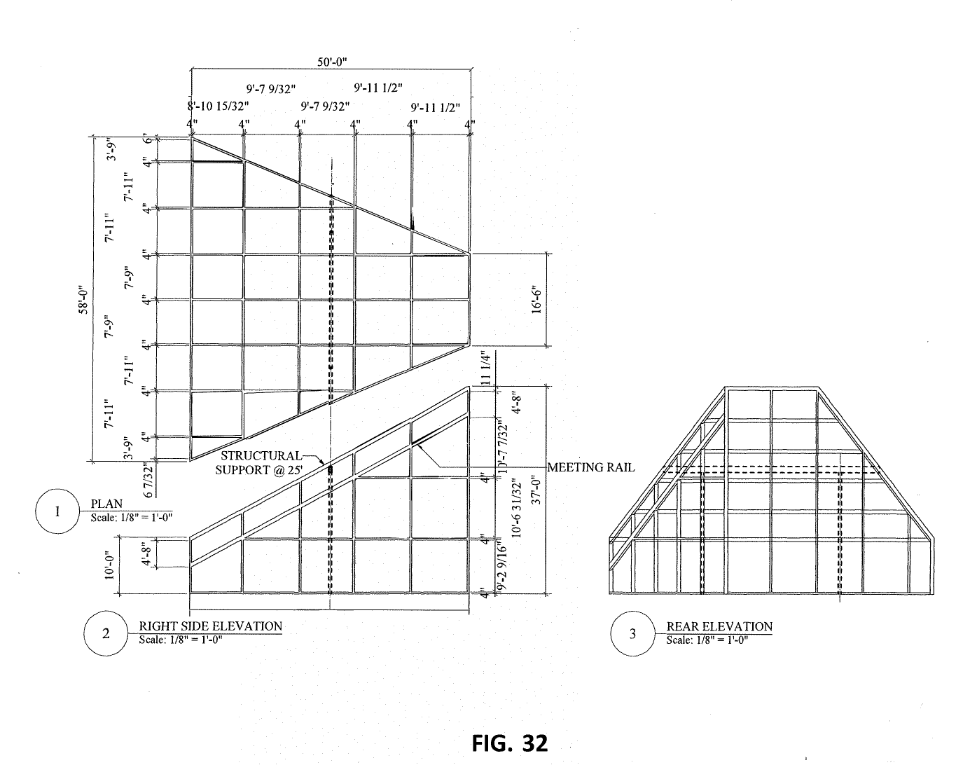

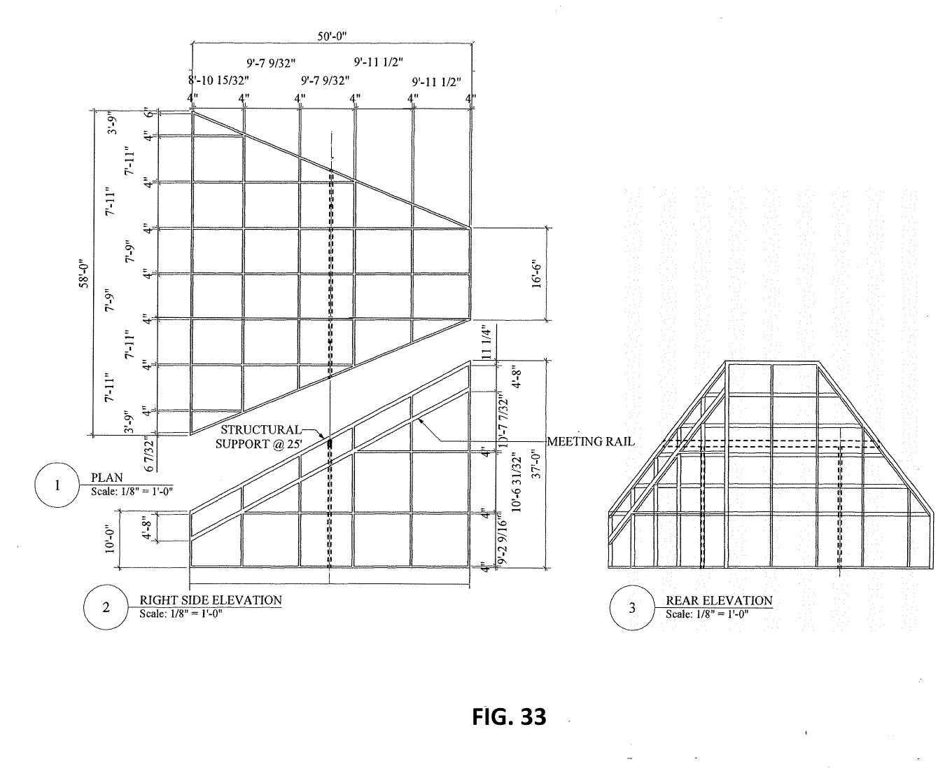

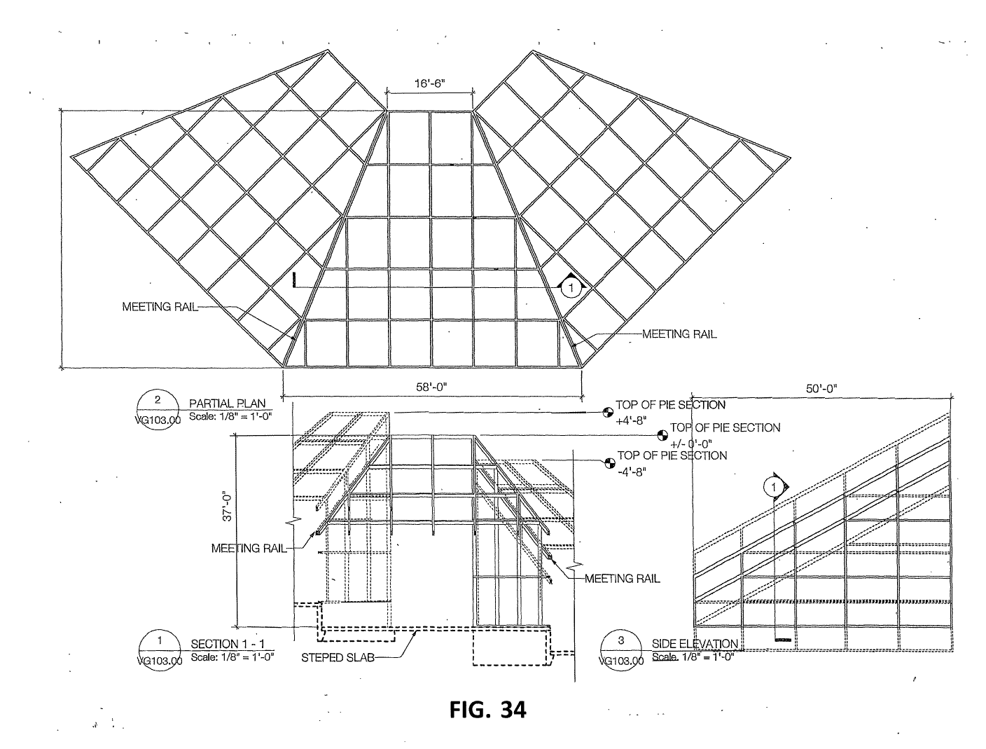

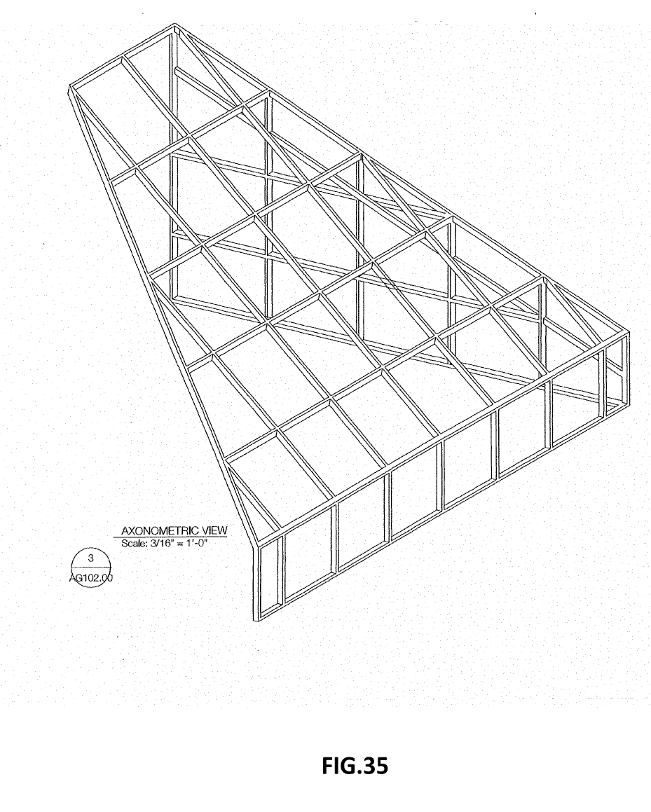

Referring now to FIGS. 32-35: Design standards are (i) withstand category 5 hurricane winds, (ii) withstand tornado force winds for standard duration, (iii) withstand storm surge forces, (iv) withstand seismic forces, (v) require no major maintenance. Quantity required: make 8 complete sections per one story structure, make 40 complete sections per 240′ structure. Note; each pie shaped glass enclosure consists of a truncated sloped glass section, a vertical front wall of 10′-0′ height and one vertical side wall. Each adjacent section forms the side closure for the next lower section. The side closure can be glazed or left open depending on the requirements of the uses. For the purposes of pricing assume all sides are glazed. The drawings represent the major structural members only. The glazier can insert whatever number of smaller mullions in the larger openings as they see fit to obtain the strongest and most economical glazing option.

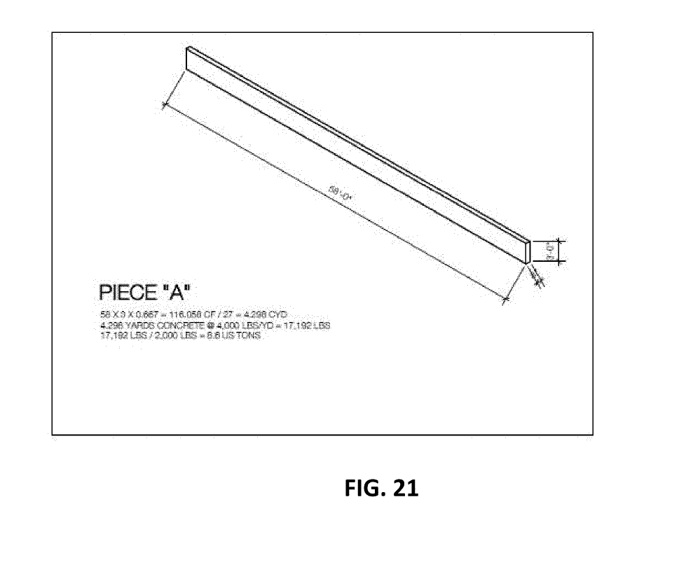

Referring now to FIG. 21, materials are 4×8 steel tube, insulated on exterior face and tied into thermally broken casing of infill glazing.

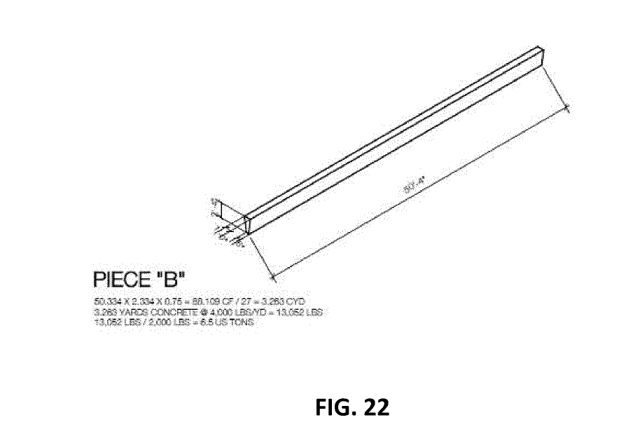

Referring now to FIG. 22, materials are 4×8 steel tube, insulated on exterior face and tied into thermally broken casing of infill glazing, and 1″ insulated engineered glass.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the arrangement for vertical farming is not intended to be exhaustive or to limit the embodiments to the precise form or structures disclosed. While specific embodiments of, and examples for, the arrangement for vertical farm are described herein for illustrative purposes, various equivalent modifications are possible within the scope of the described embodiments, as those skilled in the relevant art will recognize.

While certain aspects of the arrangement for vertical farming, according to an embodiment are presented below in certain claim forms, the inventor contemplates the various aspects of the methodology in any number of claim forms. Accordingly, the inventor reserves the right to add additional claims after filing the application to pursue such additional claim forms for other aspects of the described systems and methods.

We claim:

1. An architecture for vertical farming system, the architecture comprising:
a polygonal central core structure;
a polygonal exterior structure surrounding the polygonal central core structure to create a plurality of segments around central core structure;
one or more horizontal surfaces positioned at each segments, such that said one or more horizontal surface at each segment is higher that the horizontal surface at preceding segment by a predefined height; and
a plurality of reflective surfaces positioned between the polygonal exterior structure and the polygonal central core structure for reflecting the light internally in the architecture.

2. The architecture of claim 1, wherein the polygonal central core structure is clad with reflective material at places to reflect the light.

3. The architecture of claim 1, wherein the plurality of reflective surfaces are made of metal or plastic or glass and have a silver or matte black coating at the exterior side of the layer.

4. The architecture of claim 1 further comprises a glass pane in the polygonal exterior structure that consist of:
a first layer which is outside the pane to the exterior, a second layer which is inside to the pane to the exterior, a third layer which is outside to the pane closest to the interior and the fourth layer which is inside of the pane closest to the interior of the architecture.

5. The architecture of claim 4, wherein the second layer is coated with a film to pass beneficial part of spectrum of the sunlight to one or more growing areas and to block an undesirable spectrum of the sunlight.

6. The architecture of claim 4, wherein the third layer is coated with a coating to allow a desirable sunlight to pass through from the exterior and to reflect light received from the second layer back into the interior of the architecture.

7. The architecture of claim 1, wherein the plurality of reflective surfaces are positioned to trap and direct the maximum of the sunlight to one or more growing areas of the architecture.

8. The architecture of claim 1, wherein the plurality of horizontal surfaces are used for mounting a growing panel.

9. The architecture of claim 1, wherein the growing panels create a spiral structure to maximize the accumulation of the sunlight for growing plants/crops in the vertical farming.

10. The architecture of claim 1, wherein the polygonal structure is an octagonal structure.

11. The architecture of claim 1 wherein the horizontal surface lowest in height faces the east direction.

12. The architecture of claim 1, wherein a screen is provided at the west side of the architecture to block harmful sun rays.

13. The architecture of claim 1, wherein the polygonal central core structure comprises one or more access means to the system.
